(19) United States
(12) Patent Application Publication
(10) Pub. No.: US 2021/0256168 A1
(43) Pub. Date: Aug. 19, 2021

(54) SECURE CONNECTION

(71) Applicant: Hewlett-Packard Development Company, L.P., Spring, TX (US)

(72) Inventors: Christoph Graham, Spring, TX (US); Charles Shaver, Spring, TX (US); Roger D. Benson, Spring, TX (US)

(73) Assignee: Hewlett-Packard Development Company, L.P., Spring, TX (US)

(21) Appl. No.: 17/048,630

(22) PCT Filed: Sep. 14, 2018
(86) PCT No.: PCT/US2018/051042

§ 371 Date: Oct. 19, 2020

(51) Int. Cl. G06F 21/85; G06F 21/83; G06F 21/31; G06F 21/60; G06F 13/40

(52) U.S. Cl. CPC G06F 21/85; G06F 21/83; G06F 13/409; G06F 21/602; G06F 21/31

(57) ABSTRACT

Examples associated with secure connection are described. One example system includes a port controller. The port controller may route custom communications to a peripheral over an operable connection between the system and the peripheral via a port. The custom communications may be routed to the peripheral over a side-band channel of the operable connection between the system and the peripheral. The system also includes an application. The application may establish a secure connection the peripheral using the custom communications. The application may also receive a payload from the peripheral via the secure connection.

### BACKGROUND

Computers are pervasive throughout the world today. While some devices are designed to operate without any additional components, many computers operate by attaching themselves to numerous peripherals through which users interact with applications on the computer. These peripherals may provide output (e.g., displays, speakers), or receive input from the users (e.g., mice, keyboards, microphones). The peripherals may connect to the computer through a variety of ports, which are supported by hardware, software, firmware, and so forth that allows input received by the peripherals to be interpreted by applications operating on the computer.

### BRIEF DESCRIPTION OF THE DRAWINGS

The present application may be more fully appreciated in connection with the following detailed description taken in conjunction with the accompanying drawings.

FIG. 1 illustrates an example device associated with secure connection.

FIG. 2 illustrates an example system associated with secure connection.

FIG. 3 illustrates a flowchart of example operations associated with secure connection.

FIG. 4 illustrates an example device associated with secure connection.

FIG. 5 illustrates an example computing device in which example systems, and methods, and equivalents, may operate.

### DETAILED DESCRIPTION

Examples associated with secure connection are described. As computers have become more sophisticated, so too have methods of attacking computers to steal data stored on the computers. As a result, security measures must keep up with the sophistication of technology to prevent malicious actors from stealing data from computers. Recently, as software has become more difficult to attack, malware has begun to attack lower level software, firmware, and hardware of devices to attempt to steal passwords, privileges, control, and so forth of the devices. One technique used may involve attacking the communication stack between peripherals and applications using the input from the peripherals. Consequently, it may be desirable to protect this stack so that sensitive data can be transmitted between an application and a peripheral without exposing it to a malicious entity.

To that end, techniques disclosed herein relate to using a side-band channel of a connector between a device and a peripheral attached to the connector. The side-band channel may facilitate using a custom protocol that is understood by applications and peripherals trusted by other device components. The custom protocol may be used to establish a secure connection (e.g., via a key exchange) between the peripheral and the application, which can then be used to transmit sensitive data. By way of illustration, a smart keyboard may connect with a device using a universal serial bus (USB) Type C connector. The USB Type C connector has a power delivery channel that supports routing communications via custom channels. After an application on the device securely exchanges keys with the smart keyboard via the custom protocols, the application may request a user input a password using the smart keyboard. The smart keyboard may then receive input from the user associated with the password, but not transmit the associated keystrokes to the device. Instead, once the password has been entered, the smart keyboard may encrypt the password based on the exchanged keys to create an encrypted payload that is transmitted to the application. The application may then decrypt the payload and verify the password.

This type of exchange may allow secure transmission of data between a peripheral and an application that prevents replay and man in the middle attacks. This is because after creation of the secure connection, an attacker sitting between the peripheral and application will observe encrypted communications. The key exchange should be secure when performed according to secure cryptography techniques. Additionally, the secure connection allows the prevention of replay attacks because the secure connections can be designed to change over time, incorporate time stamps, and so forth.

It is appreciated that, in the following description, numerous specific details are set forth to provide a thorough understanding of the examples. However, it is appreciated that the examples may be practiced without limitation to these specific details. In other instances, methods and structures may not be described in detail to avoid unnecessarily obscuring the description of the examples. Also, the examples may be used in combination with each other.

“Module”, as used herein, includes but is not limited to hardware, instructions stored on a computer-readable medium or in execution on a machine, and/or combinations of each to perform a function(s) or an action(s), and/or to cause a function or action from another module, method, and/or system. A module may include a microprocessor controlled via instructions executable by the microprocessor, a discrete module, an analog circuit, a digital circuit, a programmed module device, a memory device containing instructions, and so on. Modules may include gates, combinations of gates, or other circuit components. Where multiple logical modules are described, it may be possible to incorporate the multiple logical modules into one physical module. Similarly, where a single logical module is described, it may be possible to distribute that single logical module between multiple physical modules.

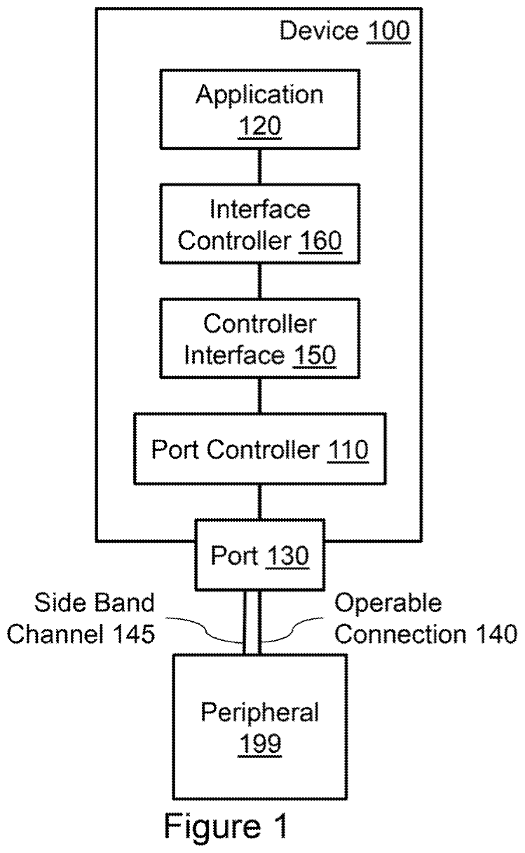

FIG. 1 illustrates an example device 100 associated with secure connection. Device 100 is connected to a peripheral 199 via a port 130. Peripheral 199 may be, for example, an input device designed to receive input from a user and provide that input to device 100, such as a mouse, keyboard, keypad, microphone, and so forth. In other examples, peripheral 199 may be a security token, an output device, and so forth. The connection between port 130 and peripheral 199 may form an operable connection 140 that allows signals to be passed between device 100 and peripheral 199. Operable connection 140 may involve, for example, hardware, software, firmware, cable(s), pin(s), and so forth.

Operable connection 140 may include several channels associated with transmitting signals between port 230 and peripheral 199. These channels may be associated with a protocol designed to facilitate transmission of signals between port 130 and peripheral 199. The protocol may dictate, for example, how data is to be ordered when transmitting information so that the transmissions can be understood by a receiving party. In some examples, data may be formed into chunks having a header including metadata about the chunk, as well as a body that includes content transmitted in the chunk. What data is included in the metadata may depend on the protocol used, and the data included in the body may depend on the type of peripheral being used. In some examples, the body may include data that will be further interpreted by various layers of the communication stack between and including peripheral 199 and application 120. For example, if peripheral 199 is a keyboard, keystroke data may be interpreted by an operating system, a word processor, and so forth to cause characters to be entered into an application and/or otherwise displayed.

Operable connection 140 may also include channels, such as side-band channel 145, that are not directly associated with transmitting content between device 100, peripheral 199, and so forth. The side-band channels may be associated with, for example, power delivery to peripheral 199, control of certain aspects of peripheral 199, and so forth. As used herein, a side-band channel is a channel associated with a connection protocol that is not used for primary data communication over that protocol. For example, a universal serial bus (USB) type C connector has a power delivery channel for providing power to peripherals 199. The power delivery channel is not typically allocated for the transmission of data between peripherals 199 and device to which the peripherals are connected, and is instead used for providing power to peripheral 199.

While side-band channels are often not used for the transmission of data, the side-band channel may be usable for communication by varying aspects of the channel assuming a device and/or peripheral are listening for such variances. For example, the power delivery channel may be able to vary current, voltage, resistance, and so forth to effectively allow conveyance of information between two participating devices. Consequently, a custom protocol relying on the side-band channel may be usable by device 100 and peripheral 199 in a way that allows private communications to occur without otherwise impacting the communications between device 100 and peripheral 199. The custom protocol may be, for example, a specialized protocol, a proprietary protocol, and so forth, that may be designed with a specific function in mind. Custom protocols may, for example, be usable by a device maker to make it difficult for malicious actors to detect certain communications between device 100 and peripheral 199.

One way side-band channel 145 may be used is to set up a secure connection between components of device 100 and peripheral 199. The secure connection may be established by, for example, exchanging security keys using side-band channel 145. The secure connection may then be used to continue communicating over side-band channel 145, to encrypt communications over a main band channel of operable connection 140, and so forth. Establishing the secure connection may allow for encrypted data to be transmitted between application 100 and peripheral 199. The encrypted data may hinder, for example, replay attacks that attempt to allow a malicious entity to pose as peripheral 199, man in the middle attacks that attempt to observe communications between peripheral 199 and application 100, and so forth.

One example manner by which the secure communication channel may be used is to transmit data to authenticate a user of device 100 and/or peripheral 199. For example, a smart keyboard including a processor may be able to, in response to a request from application 120, store a small number of keystrokes without transmitting them to device 100, encrypt the keystrokes into a payload accessible to application 120, and then transmit the encrypted payload to application 120 via side-band channel 145 and/or operable connection 140. Alternatively, a security token may be able to similarly encrypt and transmit a security value to application 120 once a secure connection has been established. In other examples, peripheral 199 may initiate setting up the secure connection with application 120.

To ensure proper operation of the communication channel between application 100 and peripheral 199, several other components of device 100 may also be involved. These other components may be part of a stack that facilitates transmission of data between application 120 and peripheral 199. For example, a port controller 110 may be a combination of firmware and hardware that directly controls transmission of signals between port 130 and peripheral 199. Controller interface 150 may sit at an operating system level that translates data in memory into hardware instructions used by port controller 110. Interface controller 160 may be a service layer application that serves as an application programming interface (API) between application 100 and the memory used by controller interface 150.

In various examples, each of application 120, port controller 110, controller interface 150, interface controller 160, and peripheral 199 may be aware of side-band communication channel 145 for the success establishment of the secure communication channel. A component being aware of the side band channel means that it is configured to receive and provide signals associated with side band channel 145. This may mean, for example, that application 120 can call API instructions of interface controller 160 that will cause interface controller to generate instructions specifically for controller interface 150 that will cause port controller 110 to send a specific message to peripheral 199 via side-band channel 145.

In some examples, device 100 may include a module for authenticating the various components to ensure that the components are trusted prior to transmitting signals using the side-band channel. This module may also, for example, verify availability of side-band channel 145, and that relevant components are configured to support communication via side-band channel 145. Thus, the verification module may prevent use of side-band channel 145 and certain features associated with side-band channel 145 when the verification module is unable to authenticate certain components. For example, if application 120 or peripheral 199 is unable to provide a credential associated with a manufacturer of device 100, the authentication module may prevent the use side-band channel 145 for establishing a secure connection between application 120 and peripheral 199 to prevent a malicious entity from potentially learning more about the custom protocol.

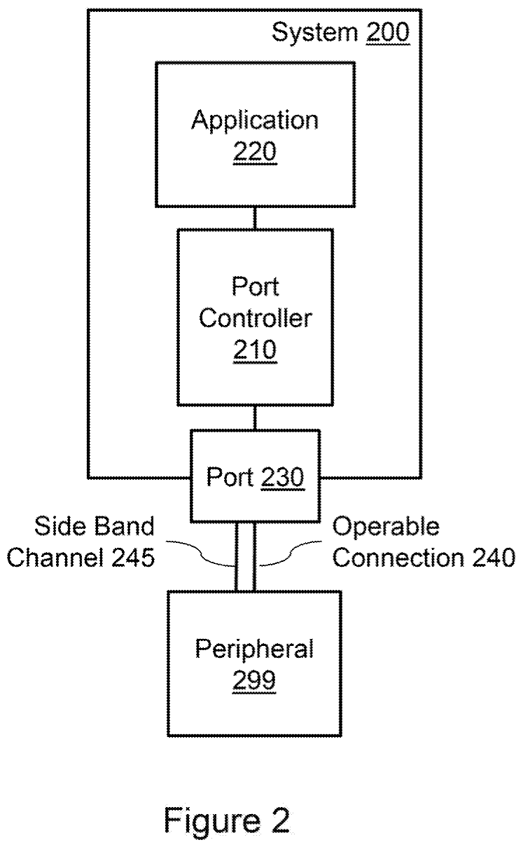

FIG. 2 illustrates a system 200 associated with secure connection. System 200 includes a port controller 210. Port controller 210 may route custom communications to a peripheral 299 via a port 230. Port 230 may be a universal serial bus (USB) type C connection. The custom communications may be routed to peripheral 299 over a side-band channel 245 of an operable connection 240 between system 200 and peripheral 299. In some examples, port 230 may be a universal serial bus (USB) type C connection, and the side-band channel may be a USB type C power delivery channel.

System 200 also includes an application 220. Application 220 may establish a secure connection to peripheral 299 using the custom communications. Application 220 may also receive a payload from peripheral 299 via the secure connection. The payload transmitted from peripheral 299 to application 220 may depend on what function peripheral 299 performs and on what type of device peripheral 299 is. For example, peripheral 299 may be a keyboard. In this example, the payload may be a password encrypted by the keyboard for use by application 299. In other examples, peripheral 299 may be a secure token. Here, the payload may be a value provided by the secure token.

In some examples, system 200 may also include an interface module (not shown). The interface module may translate communications between port controller 210 and application 220. The interface module may be made up of an interface controller and a controller interface. The interface controller may store signals received from port controller 210 in a memory of system 200. The interface controller may also control port controller 210 to transmit signals to peripheral 299 based on data retrieved from the system memory.

The controller interface may serve as an application programming interface between application 200 and the interface controller. This may be achieved by translating instructions retrieved from the application into commands that comply with a protocol associated with the with the custom communications and store them in the memory of system 200. The controller interface may also translate responses received from peripheral 299 to a format usable by application 220. In these examples, peripheral 299, port controller 210, application 220, the controller interface, and the application may all be aware of the side-band channel and the custom communications.

In some examples system 200 may also include a verification module (not shown). The verification module may authenticate application 220, peripheral 299, and so forth, prior to port controller 210 routing communications between the application and the peripheral Thus, the verification module may prevent use of side-band channel 245 and certain features associated with side-band channel 245 when the verification module is unable to authenticate certain components.

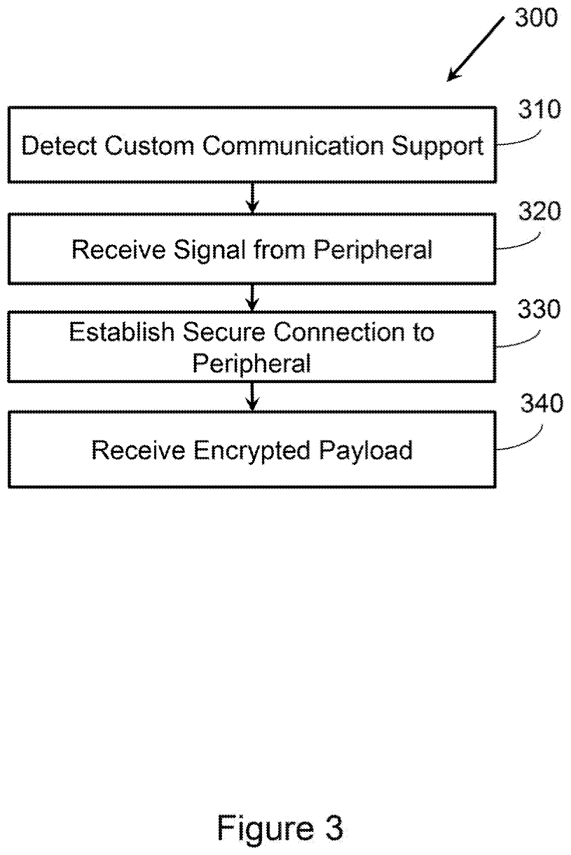

FIG. 3 illustrates an example method 300. Method 300 may be embodied on a non-transitory processor-readable medium storing processor-executable instructions. The instructions, when executed by a processor, may cause the processor to perform method 300. In other examples, method 300 may exist within logic gates and/or RAM of an application specific integrated circuit (ASIC).

Method 300 may perform various tasks associated with secure connection. Method 300 may be performed by, for example, an application operating on a device. Method 300 includes detecting support for routing communications to peripherals via a custom communication protocol at 310. The custom communication protocol may operate over a side-band channel of an operable connection between the device on which the application is operating, and a peripheral connected to the device. The operable connection may be, for example, a universal serial bus (USB) type C connection, and the side-band channel may be a power delivery channel of the USB type C connection.

Method 300 also includes receiving a signal from a peripheral at 320. The peripheral may be connected to the device via the operable connection. The signal may indicate that the peripheral is configured to communicate using the custom communication protocol. This signal may be intended to convey from an side-band aware peripheral to side-band aware peripheral that a secure connection between the application and the peripheral may be an available option.

Method 300 also includes establishing a secure connection to the peripheral at 330. The secure connection may be established using the custom communication protocol. In some examples, the secure connection may be established by exchanging security keys using the custom communication protocol. These secure keys may effectively serve as the secure connection by allowing encrypted communications to be transmitted between the peripheral and the application.

Method 300 also includes receiving an encrypted payload at 340. The encrypted payload may be received via the secure connection. The payload may include data that one or more of, the application and the peripheral would prefer not be able to be used by a malicious actor. Thus, the payload may include, for example, an encrypted password, an encrypted security key, other authentication information, personal information, and so forth.

In some examples, method 300 may also include challenging the peripheral via the side-band channel (not shown). The peripheral may be challenged upon detecting the peripheral being attached to the device via the operable connection. The peripheral may be challenged via the side-band channel to provide the signal indicating that the peripheral is configured to communicate using the custom communication protocol. When the signal is not received, the application may refrain from performing other actions associated with method 300.

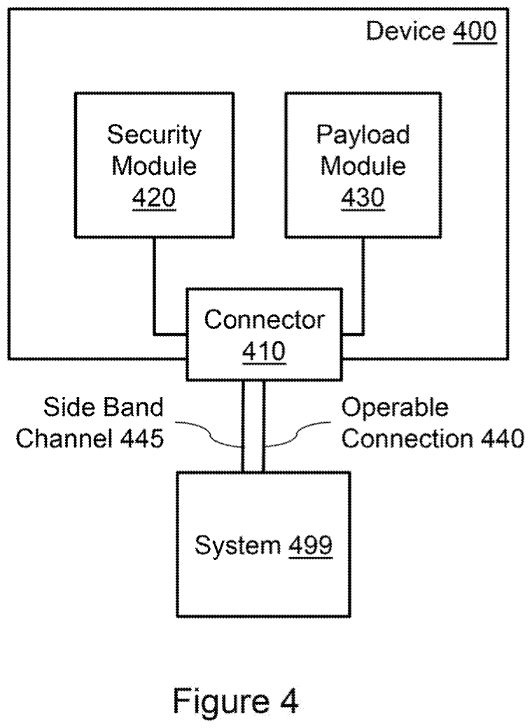

FIG. 4 illustrates a device 400. Device 400 may be a peripheral designed to connect to a system 499. Device 400 may include a connector 410 to establish an operable connection 440 to system 499. Connector 410 may be, for example, a cable with an end that connects to a port of system 499, a port that connects directly or indirectly via a cable to a corresponding port of system 499, and so forth. Operable connection 440 may include a side-band channel 445. The side-band channel may be capable of supporting custom communications between device 440 and system 499. In some examples, the connector may be a universal serial bus (USB) type C connector, and the side-band channel may be a USB type C power delivery channel.

Device 400 also includes a security module 420. Security module 420 may establish a secure connection to an application operating on system 499. The secure connection may be established using the custom communications transmitted via side-band channel 445. The secure connection may be established, for example, by exchanging security keys with the application.

Device 400 also includes a payload module 430. Payload module 430 may deliver a payload to the application using the secure connection. When device 400 is a keyboard, the payload may be, for example, an encrypted password.

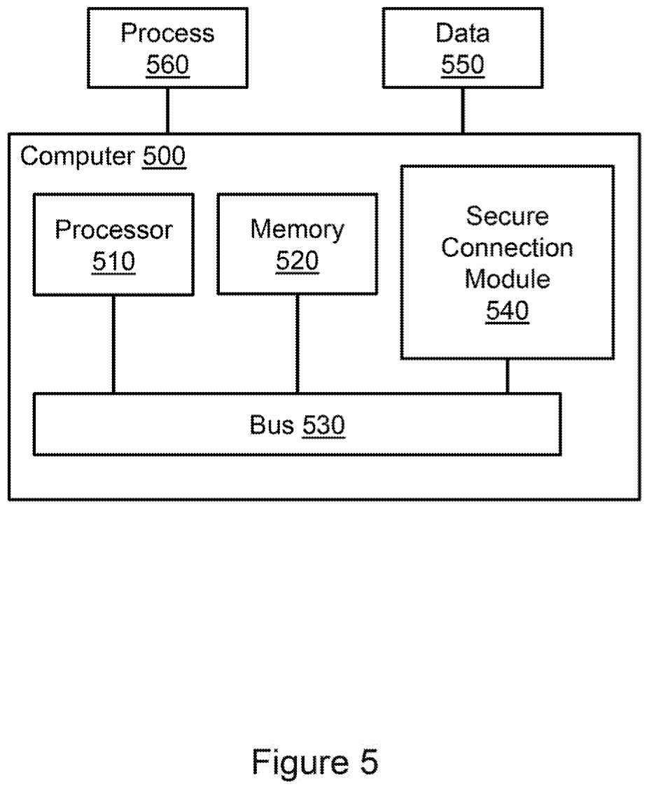

FIG. 5 illustrates an example computing device in which example systems and methods, and equivalents, may operate. The example computing device may be a computer 500 that includes a processor 510 and a memory 520 connected by a bus 530. Computer 500 includes a secure connection module 540. Secure connection module 540 may perform, alone or in combination, various functions described above with reference to the example systems, methods, and so forth. In different examples, secure connection module 540 may be implemented as a non-transitory computer-readable medium storing processor-executable instructions, in hardware, as an application specific integrated circuit, and/or combinations thereof.

The instructions may also be presented to computer 500 as data 550 and/or process 560 that are temporarily stored in memory 520 and then executed by processor 510. The processor 510 may be a variety of processors including dual microprocessor and other multi-processor architectures. Memory 520 may include non-volatile memory (e.g., read-only memory, flash memory, memristor) and/or volatile memory (e.g., random access memory). Memory 520 may also be, for example, a magnetic disk drive, a solid state disk drive, a floppy disk drive, a tape drive, a flash memory card, an optical disk, and so on. Thus, memory 520 may store process 560 and/or data 550. Computer 500 may also be associated with other devices including other computers, devices, peripherals, and so forth in numerous configurations (not shown).

It is appreciated that the previous description of the disclosed examples is provided to enable any person skilled in the art to make or use the present disclosure. Various modifications to these examples will be readily apparent to those skilled in the art, and the generic principles defined herein may be applied to other examples without departing from the spirit or scope of the disclosure. Thus, the present disclosure is not intended to be limited to the examples shown herein but is to be accorded the widest scope consistent with the principles and novel features disclosed herein.

What is claimed is:

1. A system, comprising:
a port controller to route custom communications to a peripheral over an operable connection between the system and the peripheral via a port, where the custom communications are routed to the peripheral over a side-band channel of the operable connection between the system and the peripheral; and
an application to establish a secure connection to the peripheral using the custom communications and to receive a payload from the peripheral via the secure connection.

2. The system of claim 1, further comprising an interface module to translate communications between the port controller and the application.

3. The system of claim 2, where the interface module comprises:
an interface controller to store signals received from the port controller in a memory of the system and to control the interface controller to transmit signals based on data retrieved from the system memory; and
a controller interface to serve as an application programming interface between the application and the interface controller by translating instructions retrieved from the application into commands that comply with a protocol associated with the custom communications, and to translate responses received from the peripheral to a format usable by the application.

4. The system of claim 3, where the peripheral, the port controller, the interface controller, the controller interface, and the application are aware of the side-band channel and the custom communications.

5. The system of claim 1, where the port is a universal serial bus (USB) type C connection and where the side-band channel is a USB type C power delivery channel.

6. The system of claim 1, where the peripheral is a keyboard, and where the payload is a password encrypted by the keyboard for use by the application.

7. The system of claim 1, where the peripheral is a secure token, and where the payload is a value provided by the secure token.

8. The system of claim 1, comprising a verification module to authenticate one of the application and the peripheral prior to the port controller routing communications between the application and the peripheral.

9. A method, comprising:
detecting, by an application, support for routing communications to peripherals via a custom communication protocol that operates over a side-band channel of an operable connection between a device on which the application is running and a peripheral connected to the device;
receiving a signal from a peripheral connected to the device via the operable connection indicating that the peripheral is configured to communicate using the custom communication protocol;
establish a secure connection to the peripheral using the custom communication protocol;
receive an encrypted payload from the peripheral via the secure connection.

10. The method of claim 9, where the operable connection is a universal serial bus (USB) type C connection, and where the side-band channel is a power delivery channel of the USB type C connection.

11. The method of claim 9, comprising: upon detecting the peripheral being attached to the device via the operable connection, challenging the peripheral via the side-band channel to provide the signal indicating that the peripheral is configured to communicate using the custom communication protocol.

12. A device, comprising:
a connector to establish an operable connection to a system, where the operable connection includes a side-band channel capable of supporting custom communications between the device and the system;
a security module to establish a secure connection to an application operating on the system using the custom communications; and
a payload module to deliver a payload to the application using the secure connection.

13. The device of claim 12, where the connector is a universal serial bus (USB) type C connector and where the side-band channel is a USB type C power delivery channel.

14. The device of claim 12, where the security module establishes the secure connection by exchanging security keys with the application.

15. The device of claim 12, where the device is a keyboard and where the payload is an encrypted password.
